(19) United States
(12) Patent Application Publication
(10) Pub. No.: US 2012/0003987 A1
(43) Pub. Date: Jan. 5, 2012

(54) Method And Apparatus For Optimizing Network Throughput

(76) Inventors: Subramanian Vasudevan, Morristown, NJ (US); Kathiravetpillai Sivanesan, Richardson, TX (US); Ganapathy Subramanian Sundaram, Hillsborough, NJ (US); Ashok N. Rudrapatna, Basking Ridge, NJ (US)

(21) Appl. No.: 12/827,380

(22) Filed: Jun. 30, 2010

(51) Int. Cl. H04W 72/04

(52) U.S. Cl. 455/453

(57) ABSTRACT

A method is provided a wireless system for optimizing network throughput in a wireless communication system. More particularly, the methodology of the invention evaluates the both individual user data throughput as well as the data throughput of a larger user population, in determining the base station to which a user should attach when entering the wireless system. In an alternate embodiment, the invention methodology evaluates such individual user data throughput and the user population throughput in determining whether or not to handoff a data session for a user from one base station to the other.

### FIELD OF THE INVENTION

The present invention generally relates to managing throughput in a wireless communications system.

### BACKGROUND OF THE INVENTION

In 4G macro-cellular wireless networks, such as LTE or WiMAX, users communicate bi-directionally with a single base station, typically the closest base station (i.e., “closest” from an RF propagation-loss perspective), chosen from a set of neighboring base stations that provide wireless coverage over a geographical area in which the user is located. As the user moves, the mobile terminal associated with that user proposes re-attachment (or handover) to a different base station based on relative or absolute values of received signal strength from the new (or target) base station. This base station accepts the user for handover to it as the new serving base station, if the reported signal strength is sufficiently strong (either in absolute value or relative to that of the current serving base station).

Heterogeneous networks are now being developed wherein cells of smaller size are embedded within the coverage area of larger macro cells, primarily to provide increased capacity in targeted areas of data traffic concentration. Such heterogeneous networks try to exploit the spatial variations in user (and traffic) distribution to efficiently increase the overall capacity of the wireless network.

However, as a result of the significant non-uniformities in distribution of user traffic, the heterogeneous networks are also characterized by the quality that the data throughput which a user receives from a given base station (whether at one of the embedded small cells or at the umbrella macro cell) depends highly on the number of users contending for service from that base station.

### SUMMARY OF INVENTION

A method is provided a wireless system for optimizing network throughput in a wireless communication system. More particularly, the methodology of the invention evaluates the both individual user data throughput as well as the data throughput of a larger user population, in determining the base station to which a user should attach when entering the wireless system. In an alternate embodiment, the invention methodology evaluates such individual user data throughput and the user population throughput in determining whether or not to handoff a data session for a user from one base station to the other.

### BRIEF DESCRIPTION OF THE FIGURES

The teachings of the present invention can be readily understood by considering the following detailed description in conjunction with the accompanying drawings, in which:

FIG. 1 provides a schematic depiction of a wireless system arrangement in which the method of the invention may be implemented.

### DETAILED DESCRIPTION

In the following description, for purposes of explanation and not limitation, specific details are set forth such as particular architectures, interfaces, techniques, etc., in order to provide a thorough understanding of illustrative embodiments of the invention. However, it will be apparent to those skilled in the art that the invention may be practiced in other illustrative embodiments that depart from these specific details. In some instances, detailed descriptions of well-known devices, circuits, and methods are omitted so as not to obscure the description of described embodiments with unnecessary detail. All principles, aspects, and embodiments, as well as specific examples thereof, are intended to encompass both structural and functional equivalents thereof. Additionally, it is intended that such equivalents include both currently known equivalents as well as equivalents developed in the future.

The invention is described hereafter in terms of user admission to a wireless network as a function of both user and network performance. The invention methodology is applied for both admission of a new user to one of two or more cells in a network and to handover of a user from a serving cell to another cell in the network. While the disclosed invention methodology is described for an exemplary case of a heterogeneous network having at least one macro cell and one or more small cells embedded within the macro cell, the invention methodology is applicable to both typical macro cellular networks and wireless networks employing multiple radio access technologies as well, and the claimed invention is intended to cover all such applications of that methodology. Moreover, the invention methodology is described for simplicity of illustration in terms the user admission decision being between a first and a second cell of the wireless network, but it should be clear that the methodology can be readily extended to admission among multiple cells of the network. Accordingly, the use the illustrative two-cell case in the description following is solely for purposes of illustrating the invention principles, and is not in any way intended to limit the scope of the invention.

As noted above, the invention is herein described in terms of an exemplary application of the invention methodology to a heterogeneous network consisting of a single macro cell (characterized as cell/base station 1) with one embedded small cell (characterized as cell/base station 2). It will be apparent to those of skill in the art that the invention methodology scales to any number of macro and small cells or conventional macro cellular network with multiple macro cells.

As a predicate to the further description of the invention, a number of parameter values, which will vary with particular wireless networks and which will either be known to, or calculable by the network operator, need to be identified for application in the invention methodology.

The loading for each cell, in terms of the number of users currently attached to each cell, can be represented by k such that k₁ represents the number of users currently attached to cell 1 and k₂ represents the number of users currently attached to cell 2.

A minimum user throughput required to achieve acceptable quality of service for a given call type can readily be determined by a system operator, and will be designated herein as MinThput.

Metrics are also needed that are reflective of user and network throughput, and that can be used to evaluate the impact of a particular cell admission in respect to user and network performance. To that end, it is assumed that a given user seeking admission to one of the two exemplary cells (or, in an alternative embodiment, considering handover from one cell to the other) can, in principle (and in the absence of any other contending users) achieve average data rates of r₁ and r₂ respectively for the two cells, as determined based on the user's received signal to interference plus noise (SINR) ratio from the base stations in those two cells. The expected or achieved user throughput at each of these cells will be readily understood as a valid measure of the expected or achieved performance.

Assuming, for illustrative purposes, that the user is currently part of the user pool at cell/base station 1, the user's throughput can be written as

t₁=g₁*r₁/k₁

where g₁ is the load dependent scheduling gain of the user at base station 1. The scheduling gain is a measure of how much the performance of the user improves as a result of the presence of other users in the system (leading to more opportune moments for scheduling these users with time varying radio channels). The expression for user throughput can be understood as a tradeoff between scheduling gain and throughput loss due to the presence of other users in the system that need to also be scheduled. The division by k₁ in particular assumes that the scheduler at the base station is an equal time scheduler providing essentially 1/k₁ of the available time to each user.

While in the most general case, scheduling gain can be both user and load level dependent, a simplifying assumption is made for the purpose of illustrating the methodology of the invention that the scheduling gain is the same for all users in a cell.

A measure of network performance is also needed. A good definition (though by no means exclusive) of a network, in the context of heterogeneous networks, is an umbrella macro-cell along with all the small cells embedded within it. The throughput of such a network in the illustrative two-cell example followed here is simply the sum of the aggregate user throughputs at these two cells. The aggregate cell throughput for each of the cells taken individually is denoted T₁ and T₂, respectively, and the network throughput, in the absence of admission for a new user (or handover of a user from one cell to the other), is therefore represented as T₁+T₂.

Aggregate measures of performance across networks are also often times called utility functions and a frequently proposed utility function for a network consisting of multiple cells is not the sum of aggregate cell throughputs, but rather their product (T₁*T₂). A motivation for use of such a measure is that this measure extends the metric used by proportional fair (PF) schedulers within a cell (maximizing the product of user throughputs). There are two problems with such an extrapolation. First, the metric most meaningful to the operator of a wireless network—whose basic motivation is that of obtaining a return on investment in deploying the network (and the licensing the spectrum resources)—is the aggregate number of bits that can be transmitted via that network. It is, of course, also critical that the system be fair to users in poor radio conditions, but such fairness (to a user relative to all other users in the same cell) is already guaranteed by the PF schedulers located at each cell. Secondly, the use of the product-utility metric will require centralized scheduling decisions when a distributed implementation of scheduling (at each base station) is usually desired.

Accordingly, for a preferred embodiment of the invention, as described herein, the summation-utility metric will be used as a measure of network performance. With this background, a determination of user and network performance metrics according to the invention methodology is described hereafter for two invention embodiments:
(1) admission of a new user to one of two available wireless cells; and
(2) handover of a user from a one wireless cell to another cell.

In the first embodiment, a new user is entering the network and a decision is required as to whether the user is to receive service from cell/base station 1 or cell/base station 2 (assuming both are able to admit the user into their respective user pools). For this embodiment, since the user has not yet entered the system, expected user throughputs are needed for the two base stations in the event that the user is admitted to a respective one of cell 1 or cell 2. These expected user throughputs can be expressed as:

t₁=g₁_{ₖ₁₊₁}*r₁/(k₁+1)

t₂=g₂_{ₖ₂₊₁}*r₂/(k₂+1)

where the throughputs t₁ and t₂ are underlined to show that these are expected values.

and not actual throughputs, with the same convention being adopted for the scheduling gain terms. Furthermore the subscripts on the scheduling gain terms make the dependence on the number of users explicit. The divisors take into account the fact that admission of the user into either cell increases its user population by one.

It can be assumed that the user seeking admission to either cell 1 or cell 2 has an objective of admission to the cell providing the highest throughput for the user itself. However, the network objective will be the maximization of overall network throughput. The methodology of the invention operates to provide a balance between those sometimes competing objectives.

If the new user is admitted to cell 1, the expected network throughput is:

T_{1(new)}=[(g₁ₖ_{₂}₊₁/g₁ₖ_{₂})(k₁/k₁+1)T₁]+t₁+T₁

If, on the other hand, the new user is admitted to cell 2, the expected network throughput is:

T_{2(new)}=[(g₂ₖ_{₂}₊₁/g₂ₖ_{₂})(k₂/k₂+1)T₂]+t₂+T₂

Having determined the expected values T_{1(new)} and T_{2(new)}, T_{1(new)} is evaluated relative to T_{2(new)} (or vice versa). If T_{1(new)} is greater than T_{2(new)} and t₁ is greater than or equal to MinThput, the new user is admitted to cell 1. If T_{1(new)} is greater than T_{2(new)} but t₁ is less than MinThput, the user is admitted to the cell with best received desired signal strength or average signal-to-noise plus interference ratio.

On the other hand, if T_{2(new)} is greater than T_{1(new)} and t₂ is greater than or equal to MinThput, the new user is admitted to cell 2. If T_{2(new)} is greater than T_{1(new)} but t₂ is less than MinThput, the user is admitted to the cell with the best received desired signal strength or average signal-to-noise plus interference ratio.

For the handover invention embodiment, the user is included in the user population at base station 2 and therefore the throughput comparison is between the currently experienced throughput at base station 2 and the expected throughput should the user connect to base station 1. These throughputs are:

$$\underline{{t}_{1}} = {r}_{1} * {\underline{{g}_{1}}}_{{k}_{1} + 1} / ( {k}_{1} + 1 ) and {t}_{2} = {r}_{2} * {g}_{2 {k}_{2}} / {k}_{2}$$

(following the same conventions as for the prior embodiment.

It can be assumed that the user's objective is to move to cell 1 if, by such a move, the user is able to obtain a higher throughput than the user is currently receiving at cell 2. The network objective, however, will again be the maximization of overall network throughput, and thus not to move the user to a different cell unless the aggregate network throughput after such a move is at least as high as the aggregate throughput with the user's current cell connection. The methodology of the invention operates to provide a balance between those sometimes competing objectives.

If the user is moved from cell 2 to cell 1, the expected network throughput is:

$${T}_{1 ( HO )} = [ ( {\underline{{g}_{1}}}_{{k}_{1} + 1} / {g}_{1 {k}_{1}} ) ( {k}_{1} / {k}_{1} + 1 ) {T}_{1} ] + \underline{{t}_{1}} + ( {\underline{{g}_{2}}}_{{k}_{2} - 1} / {g}_{2 {k}_{2}} ) ( {k}_{2} / {k}_{2} - 1 ) {T}_{2} - ( {\underline{{g}_{2}}}_{{k}_{2} - 1} / {g}_{2 {k}_{2}} ) ( {k}_{2} / {k}_{2} - 1 ) {t}_{2}$$

Having determined the expected network throughput value, T_{1(HO)}, for the case of a handover from cell 2 to cell 1, T_{1(HO)} is evaluated relative to the aggregate network throughput prior to such a handover, T₁+T₂. If T_{1(HO)} is greater than T₁+T₂ and t₁ is greater than or equal to MinThput, the user is handed over to cell 1. If T_{1(HO)} is greater than T₁+T₂, but t₁ is less than MinThput, the user is either handed over to cell 1 or left in cell 2 depending on the best received signal strength or average signal-to-noise plus interference ratio.

It will be apparent to those of skill in the art that the throughput expressions above, for both the new user embodiment and the handover embodiment, can be extended in a straightforward manner to the case where multiple users are considered for admission or for handover and have a choice of more than two cells to connect to.

A more important point to note, however, with respect to the above throughput expressions is that the expected throughputs for both the user and the network can be either calculated or estimated from known throughputs, channel conditions (that map to data rates), numbers of users, and scheduling gains (that are a function of number of users).

Furthermore both centralized and decentralized implementations of the decision making algorithm for admission or handover, are readily realizable here—a centralized implementation generally occurring at a central node that can communicate with the base stations and a decentralized implementation occurring at the base stations.

Finally by use of the expected user and network throughputs according to the invention, a decision to admit or handover users can be made in a manner to balance user and network objectives. For example, users may be admitted to a cell which results in a larger network throughput even though the user may not achieve as high a throughput in that cell as it might have in another cell. Or, handovers may be made only when both user and network throughputs are increased, and so on. Such tradeoffs can be made using policies specific to the network operator and the user in question since the framework described here provides this capability.

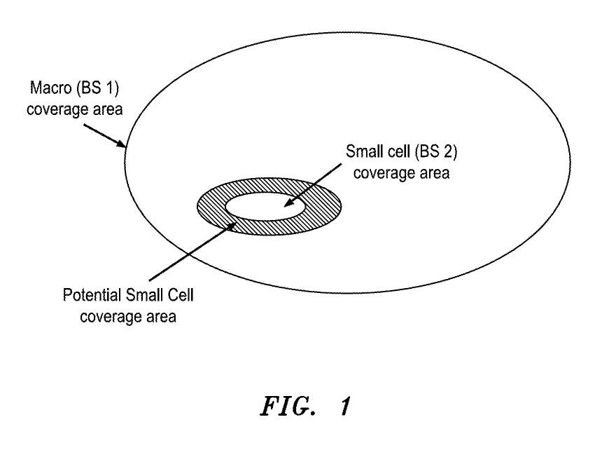

An exemplary system and method of operation for the invention is hereafter provided in the context of a handover from a macro cell to a small cell, and as schematically depicted in FIG. 1.

FIG. 1 depicts a macro cell (served by base station 1) and an embedded small cell (served by base station 2). There is an area around the small cell where it is very unlikely that service from the macro cell is viable (and thus the motivation for placing the small cell at that location) and so this is termed the small cell coverage area. The shaded annular area beyond that core small cell service area, however, can be potentially served by either the small cell base station or the macro cell base station depending on channel and loading conditions.

A user entering the potential small cell coverage area from the macro cell coverage area beyond, will likely request handover to the small cell. This request can be triggered by appropriate absolute or relative signal strength measurements of the signal transmitted by the small cell base station, as measured at the user's mobile terminal. The small cell therefore knows the rate of data transfer from it, r₂, that the channel conditions will support.

Base Station 2 sends a request to Base Station 1 for the rate r₁ with which the user is currently being served, as well as the number of users in cell 1, k1, and current aggregate throughput for cell 1, T₁, along with scheduling gains being experienced in cell 1.

Base Station 2 is able to use this information, along with its own knowledge of aggregate throughput at cell 2 (T₂), the number of users k2 and scheduling gains at cell 2, to calculate both the change in user throughput and network (cell 1+cell 2) throughput and decide whether or not to allow the handover using criteria that follow from network operator policy.

The estimated scheduling gains in the user and network throughputs (upon addition or removal of a user from the pool of users at a cell) can be estimated by a variety of methods, including analytical extrapolation from the measured scheduling gains.

In the context of LTE networks, the X2 interface between base stations may be used for information exchange between base stations.

In the case of a new user entering the network or requesting service the base stations 1 and 2 share the required information such as loading (k1, k2), aggregate throughput (T1, T2) and the expected rates (r1, r2) to make the admission decision described in the invention. A network entity in the base station(s) makes the admission decision and informs the other base station(s) via the X2 interface.

Herein, the inventors have disclosed a method for improved call admission and call handover decisions that optimize network throughput by the choice of admission/handover target. Numerous modifications and alternative embodiments of the invention will be apparent to those skilled in the art in view of the foregoing description.

Accordingly, this description is to be construed as illustrative only and is for the purpose of teaching those skilled in the art the best mode of carrying out the invention and is not intended to illustrate all possible forms thereof. It is also understood that the words used are words of description, rather that limitation, and that details of the structure may be varied substantially without departing from the spirit of the invention, and that the exclusive use of all modifications which come within the scope of the appended claims is reserved.

1. A method in a wireless communication system comprising:
determining an expected network throughput resulting from admission of a call to a cell of the network;
evaluating an impact of an alternative disposition for the call on network throughput; and
making an admission decision based on the evaluation.
